(19) United States
(12) Patent Application Publication
(10) Pub. No.: US 2026/0138563 A1
(43) Pub. Date: May 21, 2026

(54) VEHICLE CONTROL SYSTEM AND VEHICLE CONTROL METHOD

(71) Applicant: TOYOTA JIDOSHA KABUSHIKI KAISHA, Toyota-shi (JP)

(72) Inventors: Tatsuya SUGANO, Seto-shi (JP); Hidenobu KINUGASA, Nagoya-shi (JP); Takahiro YAMAMOTO, Toyota-shi (JP)

(73) Assignee: TOYOTA JIDOSHA KABUSHIKI KAISHA, Toyota-shi (JP)

(21) Appl. No.: 19/394,264

(22) Filed: Nov. 19, 2025

(30) Foreign Application Priority Data
Nov. 20, 2024 (JP) 2024-202220

(51) Int. Cl. B60R 25/24; B60R 25/04; G05D 1/227; G05D 107/13; G05D 109/10; G07C 9/00

(52) U.S. Cl. CPC B60R 25/24; B60R 25/04; G05D 1/227; G07C 9/00309; B60R 2025/0415; B60R 2325/205; G05D 2107/13; G05D 2109/10; G07C 2009/00531; G07C 2009/00793; G07C 2209/08; G07C 2209/63

(57) ABSTRACT

A vehicle control system includes a management system that manages a vehicle and a control device mounted on the vehicle. In response to a handover start request from a user device, the management system starts handover processing for transferring operating authority of the vehicle from a user to the management system. Based on the result of a first communication between the control device and a key of the vehicle, the vehicle control system confirms that the key is present within a predetermined range from the vehicle when the handover start request is given. After the presence of the key is confirmed, the control device removes a prohibition on the start-up of a travel system by an immobilizer in response to a start-up request of the travel system from the management system, on a condition that a predetermined period is in progress after the presence of the key is confirmed.

### CROSS-REFERENCES TO RELATED APPLICATION

The present disclosure claims priority under 35 U.S.C. § 119 to Japanese Patent Application No. 2024-202220, filed on Nov. 20, 2024, which is incorporated herein by reference in its entirety.

### BACKGROUND

### Technical Field

The present disclosure relates to a technique for controlling a vehicle that operates in accordance with a remote instruction in a predetermined area.

### Background Art

JP 2015-083415 A discloses a vehicle monitoring device that monitors a vehicle in a vehicle parking position. The vehicle monitoring device switches between a vehicle position notification mode and an anti-theft mode in response to a mode switching instruction.

### SUMMARY

When a user entrusts the operating authority of a vehicle to a vehicle management system in a predetermined area (e.g., a parking lot), the user operates a user device to transmit a handover start request to the vehicle management system. The user can then leave the vehicle. On the other hand, the vehicle management system needs to complete predetermined processing, such as processing for identifying (recognizing) the vehicle to be remotely operated, during a period from when the vehicle management system starts handover processing in accordance with the handover start request to when the vehicle management system transmits a start-up request of the vehicle's travel system to the vehicle. If the execution of the predetermined processing takes time and the user having a key of the vehicle moves away from the vehicle before the start-up request of the travel system is transmitted, the vehicle management system will not be able to cause the vehicle to deactivate an immobilizer, which is necessary to start up the travel system.

The present disclosure has been made in view of the problem described above, and an object thereof is to provide a technique that enables an immobilizer to be deactivated without the need to cause a user to wait near a vehicle when the user entrusts the operating authority of the vehicle to a vehicle management system in a predetermined area.

A vehicle control system according to the present disclosure controls a vehicle that operates in accordance with a remote instruction in a predetermined area. The vehicle control system includes a management system and a control device. The management system is configured to manage the vehicle. The control device is mounted on the vehicle and configured to communicate with the management system. In response to a handover start request from a user device operated by a user of the vehicle, the management system starts handover processing for transferring operating authority of the vehicle from the user to the management system. Based on a result of a first communication between the control device and a key of the vehicle, the vehicle control system executes key presence confirmation processing for confirming that the key is present within a predetermined range from the vehicle when the handover start request is given. After the presence of the key is confirmed by the key presence confirmation processing, the control device removes a prohibition on a start-up of a travel system of the vehicle by an immobilizer of the vehicle in response to a start-up request of the travel system from the management system, on a condition that a predetermined period is in progress after the presence of the key is confirmed.

A vehicle control method according to the present disclosure controls a vehicle that operates in accordance with a remote instruction in a predetermined area. The vehicle control method, which is executed by a computer, includes: in response to a handover start request from a user device operated by a user of the vehicle, starting handover processing for transferring operating authority of the vehicle from the user to a management system that manages the vehicle; based on a result of a first communication between a control device mounted on the vehicle and a key of the vehicle, executing key presence confirmation processing for confirming that the key is present within a predetermined range from the vehicle when the handover start request is given; and after the presence of the key is confirmed by the key presence confirmation processing, removing a prohibition on a start-up of a travel system of the vehicle by an immobilizer of the vehicle in response to a start-up request of the travel system from the management system, on a condition that a predetermined period is in progress after the presence of the key is confirmed.

According to the present disclosure, based on the fact that the presence of the key of the vehicle within the predetermined range from the vehicle is confirmed when the handover start request is given, the prohibition on the start-up of the travel system of the vehicle by the immobilizer is removed in response to the start-up request from the management system, even if the user is not near the vehicle. This allows the management system to start up the travel system without the need for the user to wait near the vehicle until the management system starts up the travel system after the handover processing is completed.

### BRIEF DESCRIPTION OF THE DRAWINGS

FIG. 1 is a conceptual diagram used to describe an overview of a vehicle control system according to an embodiment;

FIG. 2 is a block diagram showing an example of a configuration of a management system shown in FIG. 1;

FIG. 3 is a block diagram showing an example of a configuration of a vehicle system shown in FIG. 1;

FIG. 4 is a flowchart showing an example of the flow of processing related to deactivating an immobilizer by using key presence confirmation according to an embodiment;

FIG. 5 is a flowchart showing another example of the flow of processing related to deactivating the immobilizer by using the key presence confirmation according to an embodiment;

FIG. 6 is a flowchart showing a first example of key presence confirmation processing in step S104;

FIG. 7 is a flowchart showing a second example of the key presence confirmation processing in step S104; and

FIG. 8 is a flowchart showing an example of the flow of additional processing during parking, which is included in the processing related to deactivating the immobilizer by using the key presence confirmation according to an embodiment.

### DETAILED DESCRIPTION

Embodiments of the present disclosure will be described with reference to the accompanying drawings.

### 1. Overview of Vehicle Control System

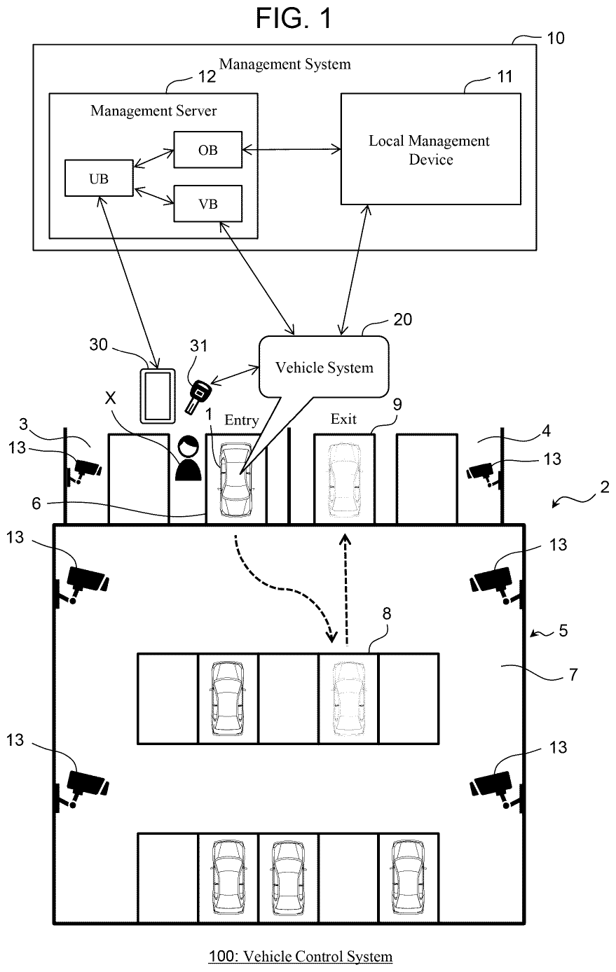

FIG. 1 is a conceptual diagram used to describe an overview of a vehicle control system 100 according to the present embodiment. The vehicle control system 100 controls a vehicle 1. The vehicle 1 is configured to operate in a predetermined area in accordance with a remote instruction INS. The predetermined area is, for example, an area in which the vehicle 1 is able to travel automatically, and the vehicle 1 travels automatically in the predetermined area in accordance with the remote instruction INS. The vehicle control system 100 includes a management system 10 and a vehicle system 20 mounted on the vehicle 1. The management system 10 manages the vehicle 1. The management of the vehicle 1 by the management system 10 includes generating a remote instruction INS. More specifically, the management system 10 manages automated driving (unmanned driving) of the vehicle 1 within the predetermined area.

### 1-1. Automated Valet Parking (AVP)

In an example shown in FIG. 1, the predetermined area is a parking lot 2. In this example, the vehicle control system 100 corresponds to an automated valet parking system configured to perform the AVP for the vehicle 1 in the parking lot 2. However, the predetermined area is not limited to the parking lot 2, but may be, for example, a city (for example, a smart city) or a part thereof. The following description will be given taking the parking lot 2 as an example of the predetermined area.

The vehicle 1 is configured to be able to execute the AVP in the parking lot 2. The vehicle 1 can travel automatically at least within the parking lot 2 without any driving operation by a user. More specifically, for example, the automated driving of the vehicle 1 within the parking lot 2 is controlled by the management system 10 that utilizes an infrastructure sensor 13. Alternatively, the automated driving may be controlled, for example, by cooperation between the management system 10 and the vehicle system 20. It should be noted that the vehicle 1 may be an automated driving vehicle that is capable of traveling automatically even outside the parking lot 2.

The parking lot 2 includes a drop-off area 3, a pick-up area 4, and a parking area 5. The vehicle 1 that enters the parking lot 2 stops at a stopping position (i.e., drop-off space) 6 provided in the drop-off area 3. At the drop-off area 3, the user gets off the vehicle 1. On the other hand, the vehicle 1 that leaves the parking lot 2 stops at the pick-up area 4. At the pick-up area 4, the user gets on the vehicle 1. The drop-off area 3 can also be called an entry area, and the pick-up area 4 can also be called an exit area. The drop-off area 3 and the pick-up area 4 may be provided separately as shown in FIG. 1 or may be provided as a drop-off/pick-up area without distinction between the drop-off and the pick-up. The parking area 5 includes a passage 7 and a plurality of parking space 8. The passage 7 is an area in which the vehicle 1 travels. The parking space 8 is a space in which the vehicle 1 is parked.

The management system 10 manages the AVP of the vehicle 1 in the parking lot 2. In one example, the management system 10 includes a local management device 11 and a management server 12 on a cloud.

The local management device 11 is installed in each parking lot 2. The local management device 11 executes, for example, the following processing. That is, the local management device 11 uses the infrastructure sensor 13 to grasp the situation of the parking lot 2 (e.g., the position and status of each vehicle 1 in the parking lot 2). The local management device 11 allocates a parking space 8 to the vehicle 1. The local management device 11 generates a remote instruction INS, communicates with the vehicle 1, and transmits the generated remote instruction INS to the vehicle 1.

The management server 12 controls the respective local management devices 11 of a plurality of parking lot 2. The management server 12 may include, for example, three servers OB, VB, and UB. The server OB is installed for each parking lot 2. The server OB manages the parking lot 2 (e.g., reservations of parking spaces 8, entry and exit of the vehicle 1) and the travel control authority of the vehicle 1. Further, the server OB communicates with the corresponding local management device 11 to collect and provide various kinds of information. The server VB manages the remote operating authority of the vehicle 1 (e.g., authority to operate the power supply of the vehicle 1). Further, the server VB communicates with vehicle 1, collects various kinds of vehicle management information (e.g., information indicating the status of the vehicle 1, identification information for the vehicle 1 (vehicle ID)), and provides various kinds of information (e.g., progress status of AVP). The server UB manages users of automated valet parking service (AVP service) (including user authentication) and manages reservations for the AVP service made by users. The server UB communicates with a user device 30 operated by a user of the AVP service. The user device 30 is, for example, a terminal device (e.g., a smartphone) of a user. The membership information of the user is registered in advance in the server UB. Further, the server UB communicates with each of servers OB and VB, and transmits and receives various kinds of information to and from each of the servers OB and VB.

An example of a flow when a user X uses the AVP service will be described below.

First, the user X reserves an AVP. For example, the user X operates the user device 30 to input information, such as the ID information of the user X, a desired parking lot 2, a desired date of use, and a desired time of use. The user device 30 transmits reservation information including the input information to the management system 10 (server UB). The management system 10 executes reservation processing based on the reservation information and transmits a reservation completion notification to the user device 30. In addition, the management system 10 transmits the authentication information depending on the reservation information to the user device 30. The user device 30 receives the authentication information and holds the received authentication information.

Entry (check-in) of the vehicle 1 into the parking lot 2 is as follows. As illustrated in FIG. 1, the vehicle 1 carrying the user X arrives at the drop-off area 3 of the parking lot 2 and stops at the stopping position 6. In the drop-off area 3, the user X (and other occupants, if any) gets off the vehicle 1.

In order to start the automated driving (i.e., automatic traveling) of the vehicle 1 based on the remote instruction INS from the management system 10 in the AVP (hereinafter, simply referred to as “AVP driving”), it is necessary to transfer operating authority of the vehicle 1 from the user X to the management system 10. To transfer the operating authority, the user X operates the user device 30 to transmit a handover start request to the management system 10 (server UB). More specifically, after the vehicle 1 arrives at the drop-off area 3, it is assumed that the user X basically makes a handover start request after getting off the vehicle 1. However, the handover start request may be made by the user X before the user X gets off the vehicle 1. The handover start request is transmitted together with, for example, the authentication information of the user X. In addition, the user device 30 used to make a handover start request before the user X gets out of the vehicle 1 is not limited to a mobile device, such as a smartphone, carried by the user X, but may also be an HMI (Human Machine Interface) device installed in the vehicle 1.

In response to the handover start request transmitted from the user device 30, the management system 10 (server UB) authenticates the user X. When the authentication is completed, the management system 10 (local management device 11) starts handover processing (i.e., authority transfer processing) for transferring the operating authority of the vehicle 1 from the user X to the management system 10.

The handover processing includes, for example, processing for establishing wireless communication between the management system 10 and the vehicle 1 (vehicle system 20), and processing for identifying the vehicle 1 as the target vehicle for the current AVP (vehicle identification processing). Identification (authentication) of the target vehicle is necessary to confirm that the vehicle 1 that is about to receive the AVP service is the vehicle 1 (target vehicle) of a genuine user X. In one example, the vehicle identification processing may be performed using a predetermined action of the vehicle 1 (e.g., blinking a light of the vehicle 1). If the vehicle 1 is a genuine target vehicle, the vehicle 1 is expected to perform the predetermined action in accordance with an instruction from the management system 10. After giving the instruction, the management system 10 uses the infrastructure sensor 13 to recognize the action performed by the vehicle 1. Then, when the recognized action matches an expected action, the management system 10 identifies, as the target vehicle, the vehicle 1 that have performed the recognized action.

When the handover processing is completed, the operating authority of the vehicle 1 is transferred from the user X to the management system 10. The management system 10 (local management device 11) executes entry processing for the vehicle 1. In the entry processing, the management system 10 communicates with the vehicle 1 and transmits a remote instruction INS (start-up request) requesting the start-up of a travel system 23 of the vehicle 1 (i.e., turning on the power supply of the travel system 23). The vehicle 1 automatically starts up the travel system 23 in accordance with the received remote instruction INS, provided that an immobilizer, which will be described below, can be deactivated. Further, the management system 10 checks the usage status of the parking lot 2, allocates an available parking space 8 to the vehicle 1, and then generates a target route for the vehicle 1 from the drop-off area 3 to the allocated parking space 8. Then, the management system 10 communicates with the vehicle 1 and transmits to the vehicle 1 a remote instruction INS requesting the vehicle 1 to perform the AVP driving along the generated target route toward the parking space 8. The management system 10 also transmits to the vehicle 1 the information about the target route, together with this remote instruction INS.

In accordance with the target route received from the management system 10, the vehicle 1 performs the AVP driving toward the parking space 8 allocated to the vehicle 1 and automatically parks in the allocated parking space 8 (Entry Completed). When the parking of the vehicle 1 is completed, the vehicle 1 notifies the management system 10 of the completion of the parking. Alternatively, the management system 10 may use an infrastructure sensor 13 installed in the parking lot 2 to detect that the parking of the vehicle 1 has been completed. After the parking of the vehicle 1 is completed, the management system 10 (local management device 11) communicates with the vehicle 1 and transmits a remote instruction INS requesting to the vehicle 1 to turn off the power supply of the travel system 23. The vehicle 1 automatically turns off the power supply in accordance with the received remote instruction INS. In addition, the management system 10 (server OB) stores, in association with the user X, information about the parking space 8 in which the vehicle 1 is parked. Additionally, the management system 10 (local management device 11) may cause the vehicle 1 to performs the AVP driving in order to move the vehicle 1 to another parking space 8 while the vehicle 1 is parked.

Exit (check-out) of the vehicle 1 from the parking lot 2 is as follows. The user X operates the user device 30 to transmit to the management system 10 (server UB), an exit request for leaving the vehicle 1. The exit request includes the authentication information of the user X. In response to the exit request, the management system 10 (server UB) authenticates the user X. When the authentication is completed, the management system 10 (local management device 11) executes exit processing for the vehicle 1.

In the exit processing, the management system 10 communicates with the vehicle 1 and executes a remote instruction INS (start-up request) requesting the vehicle 1 to start up (i.e., power on) the travel system 23 of the vehicle 1. The vehicle 1 automatically starts up the travel system 23 in accordance with the received remote instruction INS, provided that the immobilizer can be deactivated. Further, the management system 10 checks the usage status of the parking lot 2, allocates an available pick-up space 9 in the pick-up area 4 to the vehicle 1, and then generates a target route for the vehicle 1 from the parking space 8 of the vehicle 1 to the allocated pick-up space 9. Then, the management system 10 communicates with the vehicle 1 and transmits to the vehicle 1 a remote instruction INS requesting the vehicle 1 to perform the AVP driving along the generated target route toward the pick-up space 9. The management system 10 also transmits to the vehicle 1 the information about the target route, together with this remote instruction INS.

The vehicle 1 performs the AVP driving toward the allocated pick-up space 9 in accordance with the received target route. When the vehicle 1 arrives at the pick-up area 4 and automatically stops at the pick-up space 9 allocated to the vehicle 1, the vehicle 1 notifies the management system 10 of the arrival of the vehicle 1 at the pick-up area 4. Alternatively, the management system 10 may detect the arrival of the vehicle 1 using an infrastructure sensor 13 installed in the pick-up area 4.

After the vehicle 1 arrives at the pick-up area 4, the user X transmits a handback start request to the management system 10 (server UB) to transfer (return) the operating authority of the vehicle 1 from the management system 10 to the user X himself/herself. In response to the handback start request transmitted from the user device 30, the management system 10 (server UB) authenticates the user X. When the authentication is completed, the management system 10 (local management device 11) starts handback processing. When the handback processing is completed, the user X (and other occupants, if any) gets on the vehicle 1. The vehicle 1 then departs for the next destination and leaves the parking lot 2 (Exit Completed).

### 2. System Configuration Example

As described above, the vehicle control system 100 includes the management system 10 and the vehicle system 20.

### 2-1. Management System

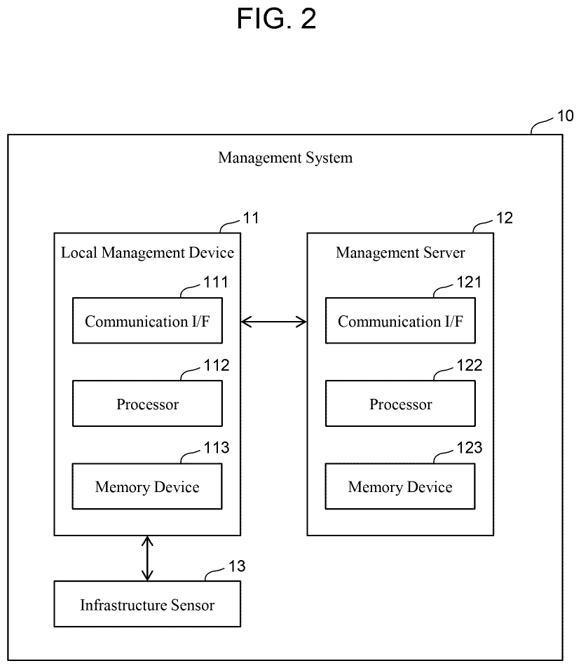

FIG. 2 is a block diagram showing an example of the configuration of the management system 10 shown in FIG. 1. The management system 10 includes the local management device 11, the management server 12 on a cloud, and one or more infrastructure sensors 13 (hereinafter, simply referred to as an infrastructure sensor 13). The infrastructure sensor 13 is installed at various locations in the parking lot 2 as shown in FIG. 1. The infrastructure sensor 13 includes, for example, one or more infrastructure cameras, and recognizes the situation of the parking lot 2 including the drop-off area 3 and the pick-up area 4. The information acquired by the infrastructure sensor 13 is transmitted to the local management device 11.

The local management device 11 includes a communication interface (communication I/F) 111, one or more processors 112 (hereinafter, simply referred to as a processor 112), and one or more memory devices 113 (hereinafter, simply referred to as a memory device 113).

The communication I/F 111 communicates with each of the vehicle 1 (vehicle system 20), the management server 12 (server OB), and the infrastructure sensor 13 via a communication network.

The processor 112 executes various kinds of processing. Examples of the processor 112 include a general purpose processor, a special purpose processor, a Central Processing Unit (CPU), a Graphics Processing Unit (GPU), an Application Specific Integrated Circuit (ASIC), a Field-Programmable Gate Array (FPGA), an integrated circuit, a conventional circuit, and/or combinations thereof. The processor 112 may also be referred to as circuitry or processing circuitry. The circuitry is hardware that is programmed to execute the recited functions or hardware that executes the functions. The memory device 113 stores various kinds of information. Examples of the memory device 113 include a volatile memory, a non-volatile memory, a hard disk drive (HDD), and a solid state drive (SSD).

The functions of the local management device 11 may be realized by cooperation between the processor 112 that executes a computer program and the memory device 113. The computer program is stored in the memory device 113. Alternatively, the computer program may be recorded in a non-transitory computer-readable recording medium or may be provided via a network.

The management server 12 (more specifically, for example, each of the three servers OB, VB, and UB) includes a communication I/F 121, one or more processors 122 (hereinafter, simply referred to as a processor 122), and one or more memory devices 123 (hereinafter, simply referred to as a memory device 123).

The communication I/F 121 communicates with each of the local management device 11, the vehicle 1 (vehicle system 20), and the user device 30 via a communication network.

An example of the configuration of the processor 122 is the same as that of the processor 112 described above. Moreover, an example of the configuration of the memory device 123 is the same as that of the memory device 113 described above. For example, the memory device 123 of the server OB stores information (e.g., map information about the parking lot 2, entry and exit time information for each vehicle 1 in the parking lot 2) about the predetermined area (e.g., parking lot 2). The memory device 123 of the server VB stores the vehicle management information described above. The memory device 123 of the server UB stores user information (e.g., identification information of each user (user ID), service reservation information). The functions of the management server 12 (e.g., each of servers OB, VB, and UB) may be realized by cooperation between the processor 122 that executes a computer program and the memory device 123. The computer program is stored in the memory device 123. Alternatively, the computer program may be recorded in a non-transitory computer-readable recording medium or may be provided via a network.

### 2-2. Vehicle System

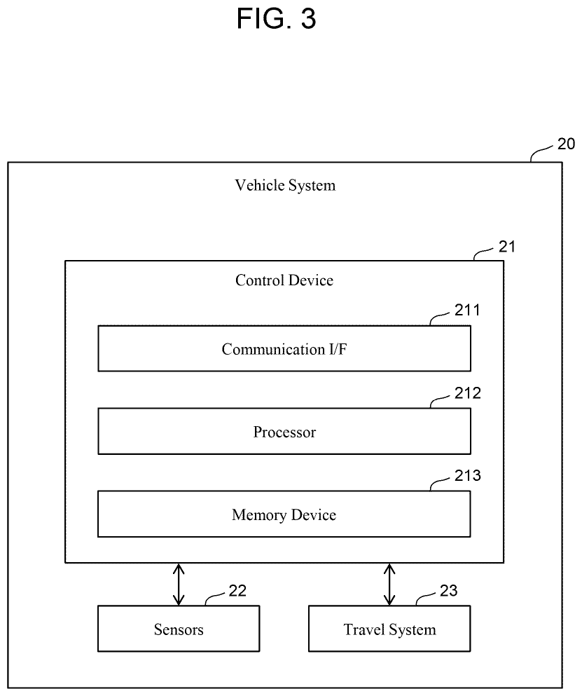

FIG. 3 is a block diagram showing an example of the configuration of the vehicle system 20 shown in FIG. 1. The vehicle system 20 is mounted on the vehicle 1 and includes a control device 21, sensors 22, and the travel system 23.

The control device 21 controls the vehicle 1 in accordance with various remote instructions INS. The control device 21 includes a communication I/F 211, one or more processors 212 (hereinafter, simply referred to as a processor 212), and one or more memory devices 213 (hereinafter, simply referred to as a memory device 213).

The communication I/F 211 communicates with the management system 10 (more specifically, with each of the local management device 11 and the management server 12 (server VB)) via a communication network. Further, the communication I/F 211 performs a communication Ckey (first communication), which will be described below, with a key 31 for the vehicle 1.

An example of the configuration of the processor 212 is the same as that of the processor 112 described above. Moreover, an example of the configuration of the memory device 213 is the same as that of the memory device 113 described above. The functions of the control device 21 may be realized by cooperation between the processor 212 that executes a computer program and the memory device 213. The computer program is stored in the memory device 213. Alternatively, the computer program may be recorded in a non-transitory computer-readable recording medium or may be provided via a network.

The vehicle system 20 has a function as the immobilizer for preventing an improper start-up (i.e., activation) of the travel system 23. For example, the control device 21 has this function. Specifically, the key 31 carried by the user X has a built-in transponder. The transponder includes a communication circuit for communicating with the vehicle 1 (control device 21) , a processor, and a memory device for storing an authentication code unique to the key 31. This authentication code is also stored in the memory device 213 of the control device 21. The communication Ckey between the vehicle system 20 (control device 21) and the key 31 is short-range wireless communication (e.g., UWB (Ultra Wideband), Bluetooth (registered trademark), NFC (Near Field Communication)).

When the control device 21 receives the authentication code from the key 31, the control device 21 (processor 212) compares the received authentication code of the key 31 with the authentication code stored in the memory device 213. As a result, when these authentication codes match, the control device 21 permits the start-up of the travel system 23. In other words, the control device 21 removes (i.e., lifts) the prohibition on starting up the travel system 23 imposed by the immobilizer.

For example, the key 31 is a smart key that has the immobilizer function described above and also allows the user X to operate the key 31 within a distance range where the communication Ckey with the vehicle 1 (control device 21) is possible to remotely start up the travel system 23. Alternatively, the key 31 may be a digital key. Specifically, the user device 30 (e.g., a smartphone) may store key information of the key 31 for causing the user device 30 to function as the digital key for the vehicle 1. The user device 30 may be configured to be usable as the digital key by the user X in place of the key 31 without the need for the physical key 31.

The sensors 22 include a recognition sensor, a vehicle state sensor, and a position sensor, for example. The recognition sensor recognizes (detects) the situation around the vehicle 1. Examples of the recognition sensor include a camera, a LIDAR (Laser Imaging Detection and Ranging), and a radar. The vehicle state sensor detects the state of the vehicle 1. Examples of the vehicle state sensor include a speed sensor, an acceleration sensor, a yaw rate sensor, and a steering angle sensor. The position sensor detects the position and orientation of the vehicle 1. An example of the position sensor is a Global Navigation Satellite System (GNSS) sensor. The sensors 22 may also include a sensor for detecting whether a door of the vehicle 1 is locked or unlocked. Furthermore, the sensors 22 may include a sensor (e.g., a seating sensor) for detecting whether or not a person is riding in the vehicle 1.

The travel system 23 is a system that operates the vehicle 1. The travel system 23 is, for example, an electric drive system, and includes an electric motor for driving the vehicle 1, a battery for supplying power to the electric motor, and a controller. The travel system 23 may include an internal combustion engine in addition to or instead of the electric motor in order to drive the vehicle 1.

### 3. Deactivating Immobilizer by Using Key Presence Confirmation

When the user X entrusts the authority to operate the vehicle 1 to the management system 10 in a predetermined area (e.g., the parking lot 2), the user X operates the user device 30 as described above to transmit the handover start request to the management system 10. The user X can then leave the vehicle 1. On the other hand, the management system 10 needs to complete predetermined processing, such as the vehicle identification processing, between starting the handover processing in accordance with the handover start request and transmitting to the vehicle 1 the start-up request for the travel system 23 of the vehicle 1. If the execution of the predetermined processing takes time and the user X having the key 31 of the vehicle 1 leaves the vehicle 1 before the start-up request for the travel system 23 is transmitted, the management system 10 will not be able to cause the vehicle 1 to verify the authentication code with the key 31. In other words, the management system 10 will not be able to cause the vehicle 1 to deactivate the immobilizer, which is necessary to start up the travel system 23.

Accordingly, in the present embodiment, when the user X entrusts the authority to operate the vehicle 1 to the management system 10 in a predetermined area (e.g., when the vehicle 1 enters the predetermined area, such as the parking lot 2), the vehicle control system 100 executes “key presence confirmation processing”. The key presence confirmation processing is processing for confirming that the key 31 is present within a predetermined range R from the vehicle 1 when the handover start request is given (i.e., issued) from the user device 30, based on the result (communication result Rcom) of the communication Ckey (first communication) between the control device 21 of the vehicle 1 and the key 31 of the vehicle 1. The key 31 to be confirmed by the key presence confirmation processing includes a digital key using the user device 30.

Then, when the presence of the key 31 is confirmed by the key presence confirmation processing, the control device 21 removes the prohibition on the start-up of the travel system 23 of the vehicle 1 by the immobilizer of the vehicle 1 in response to a request (i.e., start-up request) from the management system 10 (local management device 11) to start up the travel system 23, on the condition that a predetermined period T is in progress after the presence of the key 31 is confirmed.

### 3-1. Processing Flow

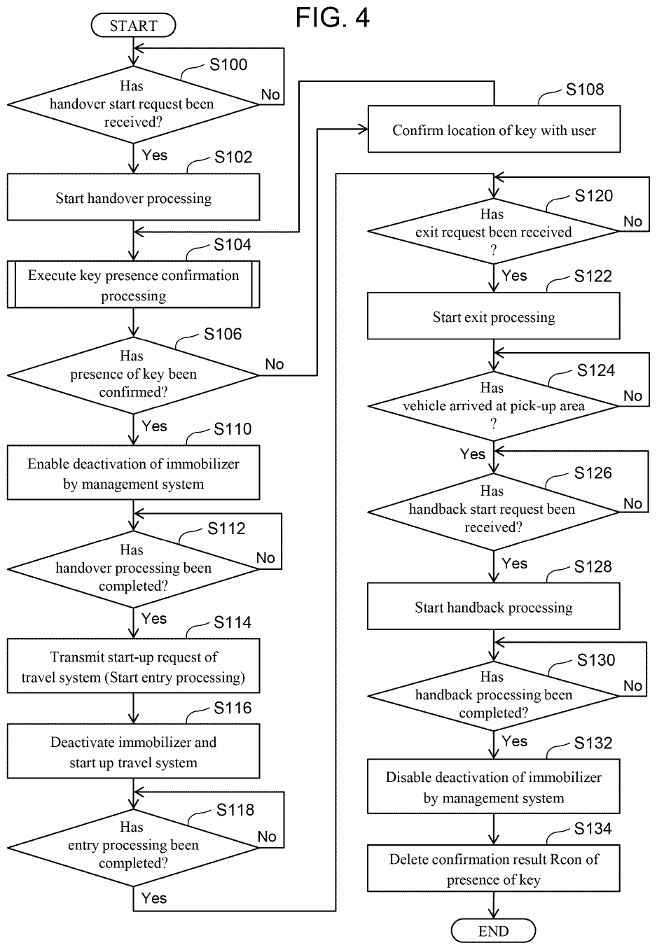

FIG. 4 is a flowchart showing an example of the flow of processing related to deactivating the immobilizer by using the key presence confirmation according to the present embodiment. The processing of this flowchart starts when, for example, the vehicle 1 arrives at the drop-off area 3. The processing is executed by the management system 10 (mainly the local management device 11) and the control device 21 in cooperation with each other.

In step S100, the local management device 11 communicates with the server UB via the server OB and determines whether or not the handover start request has been received from the user device 30. As a result, when the handover start request is received (step S100; Yes), the processing proceeds to step S102.

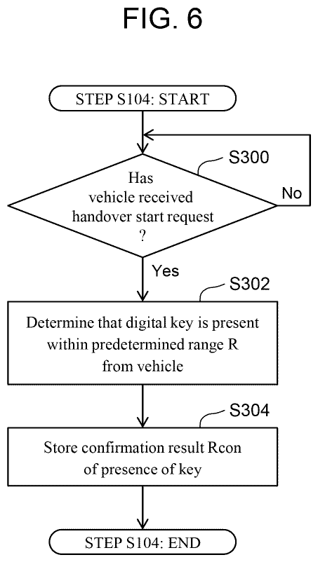

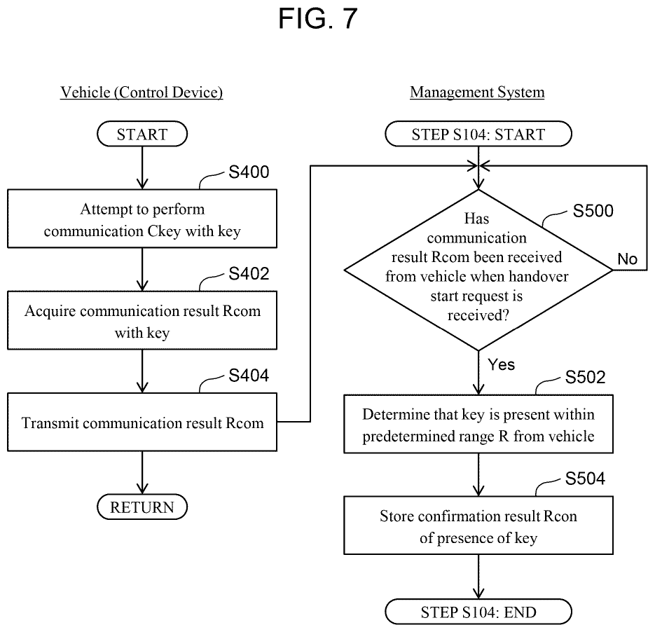

In step S102, the local management device 11 starts the handover processing described above. Then, in step S104, in conjunction with the handover start request, the “key presence confirmation processing” is executed to confirm that the key 31 is present within the predetermined range R from the vehicle 1. As will be described below with reference to FIG. 6, the key presence confirmation processing is executed by, for example, the control device 21. Alternatively, as will be described below with reference to FIG. 7, the key presence confirmation processing may be executed by the control device 21 and the management system 10 in cooperation with each other.

Additionally, as described above, the handover start request may be made not only after the user X gets out of the vehicle 1 but also before the user X gets out of the vehicle 1. Therefore, even when the user X who has the key 31 is inside the vehicle 1, the presence of the key 31 may be confirmed by the key presence confirmation processing.

As will be described below in detail, the confirmation result Rcon of the presence of the key 31 by the key presence confirmation processing is stored in the memory device 213, 113, or 123. In step S106 subsequent to step S104, the local management device 11 acquires the confirmation result Rcon stored in this manner. The confirmation result Rcon is information indicating the result of confirmation as to whether or not the key 31 is present (i.e., located) within the predetermined range R from the vehicle 1 when the handover start request is given. The local management device 11 then determines whether or not the presence of the key 31 has been confirmed based on the acquired confirmation result Rcon. As a result, when the presence of the key 31 is not confirmed (step S106; No), the processing proceeds to step S108.

In step S108, the local management device 11 transmits to the user device 30 via the servers OB and UB, a notification to confirm the location of the key 31 with user X. The notification includes, for example, a message requesting the user X to return to the vehicle 1 together with the key 31. Thereafter, the processing returns to step S104. For example, when the user X returns to the vehicle 1 in accordance with the notification, the determination result in step S106 becomes Yes.

On the other hand, when the presence of the key 31 is confirmed (step S106; Yes), the processing proceeds to step S110. In step S110, the control device 21 enables the function of deactivating the immobilizer of the vehicle 1 in response to a request from the management system 10. For example, the control device 21 turns on a flag indicating that the deactivation is valid. In addition, the deactivation of the immobilizer of the vehicle 1 according to the request from the management system 10 is normally disabled, and the processing of the flowchart shown in FIG. 4 starts in a state in which the deactivation is disabled.

In step S112 subsequent to step S110, the local management device 11 determines whether or not the handover processing has been completed. As a result, when the handover processing is completed (step S112; Yes), the processing proceeds to step S114.

In step S114, the local management device 11 transmits the start-up request of the travel system 23 to the vehicle 1 (control device 21). That is, the local management device 11 starts the entry processing described above.

In step S116 subsequent to step S114, the control device 21 receives the start-up request of the travel system 23 from the management system 10. Then, in response to the received start-up request, the control device 21 removes the prohibition on the start-up of the travel system 23 by the immobilizer of the vehicle 1 and start up the travel system 23. Thereafter, the vehicle 1 performs the AVP driving toward the allocated parking space 8.

In step S118 subsequent to step S116, the local management device 11 determines whether or not the entry processing has been completed. As a result, when the entry processing is completed (step S118; Yes), the processing proceeds to step S120.

In step S120, the local management device 11 communicates with the server UB via the server OB and determines whether or not a request to leave the parked vehicle 1 (i.e., an exit request) has been received from the user device 30. As a result, when the exit request is received (step S120; Yes), the processing proceeds to step S122.

In step S122, the local management device 11 starts the exit processing in response to the received exit request. As a result, the vehicle 1 performs the AVP driving toward the pick-up area 4. Then, in step S124, the local management device 11 determines whether or not the vehicle 1 has arrived at the pick-up area 4 (more specifically, the allocated pick-up space 9). If the vehicle 1 has arrived at the pick-up area 4 (step S124; Yes), the processing proceeds to step S126.

In step S126, the local management device 11 communicates with the server UB via the server OB and determines whether or not the handback start request has been received from the user device 30. As a result, when the handback start request is received (step S126; Yes), the processing proceeds to step S128.

In step S128, the local management device 11 starts the above-described handback processing in response to the received handback start request. The handback processing is included in the exit processing. Then, in step S130, the local management device 11 determines whether or not the handback processing is completed. As a result, when the handback processing is completed (step S130; Yes), the processing proceeds to step S132.

In step S132, the control device 21 disables the function of deactivating the immobilizer of the vehicle 1 in response to a request from the management system 10. For example, the control device 21 turns off the flag indicating that the deactivation of the immobilizer is valid. Thereafter, the processing proceeds to step S134.

Moreover, the current confirmation result Rcon of the presence of the key 31 by the key presence confirmation processing is stored on the vehicle 1 side (memory device 213 of the control device 21; see FIG. 6 described below) or on the management system 10 side (memory device 123 of the server OB or VB or memory device 113 of the local management device 11; see FIG. 7 described below). When the confirmation result Rcon is stored in the memory device 213, the control device 21 deletes the confirmation result Rcon from the memory device 213 in step S134 (that is, upon the end of the predetermined period T). Similarly, when the confirmation result Rcon is stored in the memory device 123 or 113, the management system 10 deletes the confirmation result Rcon from the memory device 123 or 113 in step S134 (that is, upon the end of the predetermined period T). More specifically, the local management device 11 transmits an instruction to delete the confirmation result Rcon to the server OB or VB, and the server OB or VB deletes the confirmation result Rcon from the memory device 123. Alternatively, the local management device 11 deletes the confirmation result Rcon from the memory device 113. By deleting the confirmation result Rcon upon the end of the predetermined period T in this manner, that is, by limiting the opportunity to use the confirmation result Rcon for the purpose of deactivating the immobilizer to the time when the AVP service is being executed, it is possible to provide an AVP service that is highly convenient for the user X in a manner that highly takes into consideration the security of the vehicle 1.

Additionally, upon the completion of the handback processing, the exit processing is completed. Then, when the user X gets into the vehicle 1 and the vehicle 1 leaves the parking lot 2, the exit of the vehicle 1 is completed.

### 3-1-1. Predetermined Period T

As already described, the control device 21 removes the prohibition on the start-up of the travel system 23 by the immobilizer in response to the start-up request, on the condition that the predetermined period T is in progress after the presence of the key 31 is confirmed.

### 3-1-1-1. First Example

In the example of the processing shown in FIG. 4, the predetermined period T ends when a handover period during which the operating authority of the vehicle 1 is transferred from the user X to the management system 10 ends, that is, when the handback processing is completed (step S130; Yes).

### 3-1-1-2. Second Example

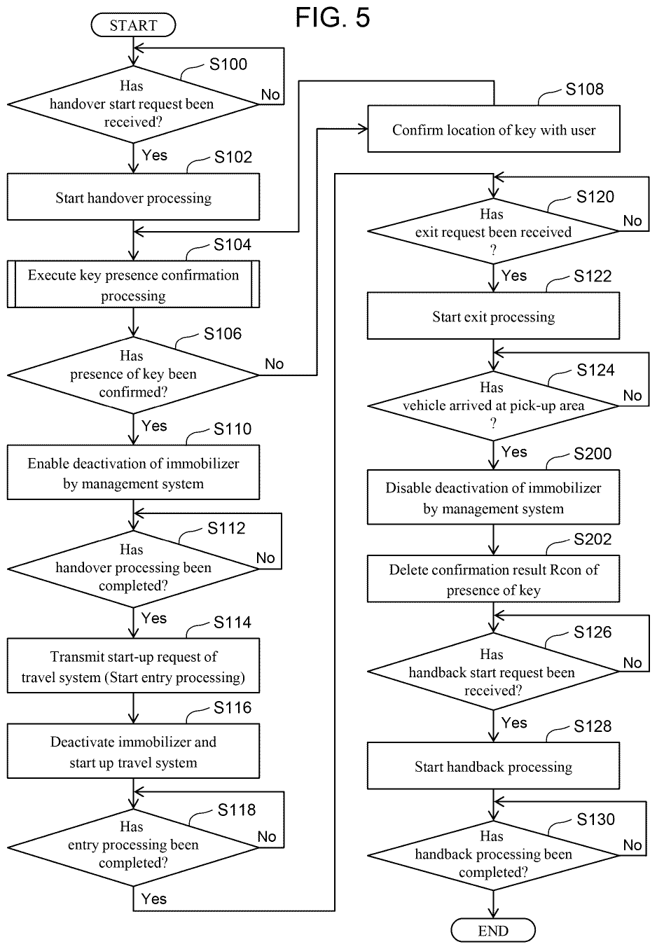

FIG. 5 is a flowchart showing another example of the flow of processing related to deactivating the immobilizer by using the key presence confirmation according to the present embodiment. The processing of this flowchart is different from the processing of the flowchart shown in FIG. 4 in the timing at which the function of deactivating the immobilizer is disabled when the vehicle 1 leaves a predetermined area (in other words, in the timing at which the predetermined period T ends).

Specifically, in FIG. 5, when the vehicle 1 arrives at the pick-up area 4 (step S124; Yes), the local management device 11 disables the function of deactivating the immobilizer of vehicle 1 in response to a request from the management system 10 (step S200). That is, in the example shown in FIG. 5, the predetermined period T ends when the vehicle 1 arrives at the pick-up area 4 (more specifically, pick-up space 9) for vehicle 1 to leave the predetermined area (e.g., parking lot 2).

Furthermore, in FIG. 5, in step S202 subsequent to step S200 (i.e., upon the end of the predetermined period T), the control device 21 (or management system 10) deletes the confirmation result Rcon from the memory device 213 (alternatively, memory device 123 or 113).

Additionally, instead of the second example shown in FIG. 5, the timing for disabling the function of deactivating the immobilizer when the vehicle 1 leaves the predetermined area may be when the start-up of the travel system 23 for moving the vehicle 1 from the parking space 8 to the pick-up space 9 upon leaving the predetermined area is completed.

### 3-1-2. First Example of Key Presence Confirmation Processing

FIG. 6 is a flowchart showing a first example of the key presence confirmation processing in step S104. In the first example, the key presence confirmation processing is executed by the control device 21. In the first example, the key 31 is a digital key, that is, the user device 30 also serves as the key 31. Further, in the first example, the handover start request is transmitted not only from the user device 30 to the management system 10 but also transmitted from the user device 30 functioning as the digital key to the control device 21 (vehicle 1) via the communication Ckey described above.

In step S300, the control device 21 determines whether or not the vehicle 1 (control device 21) has received the handover start request via the communication Ckey. As a result, if the vehicle 1 has received the handover start request (step S300; Yes), the processing proceeds to step S302.

In step S302, the control device 21 determines that the digital key (user device 30) is present within the predetermined range R from the vehicle 1 when the handover start request is given (i.e., issued), upon receiving the handover start request from the user device 30 via the communication Ckey. That is, the control device 21 acquires (generates) the confirmation result Rcon indicating that the presence of the digital key (user device 30) has been confirmed. In addition, the predetermined range R corresponds to the range in which the communication Ckey between the digital key (user device 30) and the vehicle 1 is possible. Therefore, if the vehicle 1 is able to communicate with the user device 30 using the communication Ckey, it can be said that the user device 30 (i.e., digital key) is present within the predetermined range R from the vehicle 1.

In step S304 subsequent to step S302, the control device 21 stores the generated confirmation result Rcon in the memory device 213.

According to the first example described above, the key presence confirmation processing can be smoothly performed by using the communication Ckey between the vehicle 1 and the user device 30 that functions as the digital key.

### 3-1-3. Second Example of Key Presence Confirmation Processing

FIG. 7 is a flowchart showing a second example of the key presence confirmation processing in step S104. In the second example, the key presence confirmation processing is executed by the control device 21 and the management system 10 in cooperation with each other. In the second example, the key 31 may be either a physical key (e.g., a smart key) or a digital key.

The control device 21 periodically attempts to perform the communication Ckey with the key 31, regardless of the timing at which the key presence confirmation processing in step S104 is performed. Specifically, in step S400, the control device 21 attempts to perform the communication Ckey with the key 31. Then, in step S402, the control device 21 acquires (generates) the communication result Rcom with the key 31. The communication result Rcom is information indicating whether or not the communication Ckey is established.

Then, in the second example, in step S404, the control device 21 transmits (uploads) the communication result Rcom to the management system 10 (server VB). The control device 21 repeatedly executes the processing of steps S400 to S404 at predetermined time intervals. As described above, in the second example, the control device 21 periodically transmits the communication result Rcom, which is the result of the periodically performed communication Ckey, to the management system 10.

As described above, when the handover start request is transmitted from the user device 30, the local management device 11 receives the handover start request via the servers UB and OB. Further, the local management device 11 periodically receives the communication result Rcom transmitted from the vehicle 1. In step S500, the local management device 11 determines whether or not the local management device 11 has received the communication result Rcom indicating that the communication Ckey is established when the handover start request is received.

When the determination result in step S500 is Yes, the local management device 11 determines that the key 31 is present within the predetermined range R from the vehicle 1 when the handover start request is given, upon receiving the communication result Rcom indicating that the communication Ckey is established when the handover start request is received. That is, the local management device 11 acquires (generates) the confirmation result Rcon indicating that the presence of the key 31 has been confirmed. In addition, the predetermined range R corresponds to the range in which the communication Ckey between the key 31 and the vehicle 1 is possible. Therefore, if the vehicle 1 is able to communicate with the key 31 using the communication Ckey, it can be said that the key 31 is present within the predetermined range R from the vehicle 1.

In step S504 subsequent to step S502, the management system 10 stores the generated confirmation result Rcon in the memory device 123 or 113. More specifically, the local management device 11 transmits an instruction to the server OB or VB to store the confirmation result Rcon, and the server OB or VB stores the confirmation result Rcon in the memory device 123 thereof. Alternatively, the local management device 11 stores the confirmation result Rcon in the memory device 113.

According to the second example described above, the key presence confirmation processing can be smoothly performed by using the communication Ckey that is periodically performed between the key 31 and the vehicle 1.

Additionally, the “predetermined range R” in the key presence confirmation processing is not limited to the range in which the communication Ckey between the key 31 and the vehicle 1 is possible as in the first and second examples described above. That is, the predetermined range R may be, for example, a predetermined distance range from the vehicle 1. In this example, the control device 21 may determine whether or not the key 31 is present within the predetermined distance range (i.e., predetermined range R) by using, for example, the result of measuring the distance between the vehicle 1 and the key 31 using the communication Ckey (e.g., UWB).

### 3-1-4. Additional Processing During Parking Using AVP Service

In the vehicle control system 100, when the entry of the vehicle 1 is completed and the vehicle 1 is parked in the parking space 8 in the parking area 5, the following processing may be additionally executed.

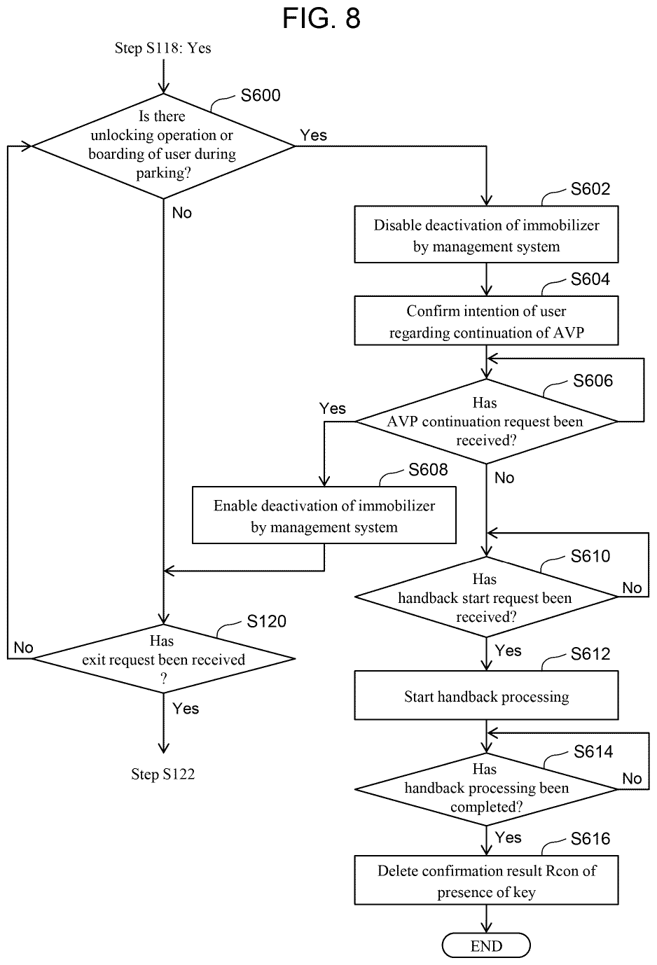

FIG. 8 is a flowchart showing an example of the flow of additional processing during parking, which is included in the processing related to deactivating the immobilizer by using the key presence confirmation according to the present embodiment. This additional processing is executed by the management system 10 (mainly the local management device 11) and the control device 21 in cooperation with each other.

In FIG. 8, when the determination result in step S118 (see FIG. 4 or 5) is Yes, the processing proceeds to step S600. In step S600, the local management device 11 determines whether or not the user X has unlocked doors of the vehicle 1 or has gotten into the vehicle 1 while the vehicle 1 is parked. The unlocking operation or boarding of the user X can be detected, for example, by using the sensors 22 mounted on the vehicle 1. Therefore, the local management device 11 can acquire detection information from the sensors 22 from the vehicle 1 via the servers VB, UB, and OB, for example, and make the determination in step S600 based on the acquired detection information. Alternatively, for this determination, the local management device 11 may use the infrastructure sensor 13 to detect the unlocking operation or boarding of the user X, for example.

When there is neither unlocking operation nor boarding of the user X (step S600; No), the local management device 11 determines whether or not there is a request (i.e., exit request) to leave the vehicle 1 (step S120). In the processing shown in FIG. 8, when there is no exit request (step S120; No), the processing returns to step S600. On the other hand, when there is the unlocking operation or boarding of the user X (step S600; Yes), the processing proceeds to step S602.

In step S602, the control device 21 disables the function of deactivating the immobilizer of the vehicle 1 in response to a request from the management system 10. That is, although the predetermined period T has not yet elapsed, the control device 21 disables the removal of the prohibition on the start-up of the travel system 23 by the immobilizer.

In step S604 subsequent to step S602, the local management device 11 transmits to the user device 30 via the servers OB and UB, a notification to confirm the intention of the user X regarding the continuation of the AVP service. Then, the processing proceeds to step S606.

In step S606, the local management device 11 communicates with the server UB via the server OB and determines whether or not the local management device 11 has received from the user device 30, an AVP continuation request from the user X that requests the continuation of the AVP service. As a result, when the AVP continuation request is received (step S606; Yes), the processing proceeds to step S608.

In step S608, the control device 21 enables the function of deactivating the immobilizer of the vehicle 1 in response to a request from the management system 10. That is, in response to the AVP continuation request from the user X, the control device 21 re-enables the removal of the prohibition on the start-up of the travel system 23 by the immobilizer.

On the other hand, when a response is received from the user X indicating that the AVP service is not desired to be continued (step S606; No), the local management device 11 communicates with server UB via server OB and determines whether or not the handback start request has been received from the user device 30 (step S610). As a result, when the handback start request is received (step S610; Yes), the local management device 11 starts the handback processing (step S612). Then, when the handover processing is completed (step S614; Yes), that is, when the handover period had ended, the control device 21 or the management system 10 deletes the confirmation result Rcon by the same processing as in step S134 (step S616).

### 3-2. Effect

As described above, according to the vehicle control system 100 of the present embodiment, based on the fact that the presence of the key 31 of the vehicle 1 within the predetermined range R from the vehicle 1 is confirmed when the handover start request is given, the prohibition on the start-up of the travel system 23 of the vehicle 1 by the immobilizer is removed (i.e., lifted) in response to the start-up request from the management system 10, even if the user X is not near the vehicle 1. This allows the management system 10 to start up the travel system 23 without the need for the user X to wait near the vehicle 1 until the management system 10 starts up the travel system 23 after the handover processing is completed. This leads to improved convenience for the user X in the automated driving service (e.g., AVP service) in the predetermined area.

Moreover, as in the first example described above (see Section 3-1-1), the predetermined period T during which the prohibition on the start-up of the travel system 23 by the immobilizer is removed may end when the handover period ends. This makes it possible to appropriately limit the period during which the deactivation of the immobilizer is effective in consideration of the security of the vehicle 1 while enabling the start-up of the travel system 23 in response to the start-up request from the management system 10 when the vehicle 1 enters and leaves the predetermined area.

Moreover, as in the second example described above (see section 3-1-1), the predetermined period T may end when the vehicle 1 arrives at the pick-up area 4 in order to leave the predetermined area. According to this example, even during the handover period, the deactivation of the immobilizer becomes invalid after the arrival of the vehicle 1 at the pick-up area 4. This makes it possible to more appropriately limit the period during which the deactivation of the immobilizer is effective so as to further enhance the security of the vehicle 1 while enabling the start-up of the travel system 23 in response to the start-up request from the management system 10 when the vehicle 1 enters and leaves the predetermined area.

Furthermore, as described above in Section 3-1-4, when the user X unlocks the doors of the vehicle 1 or gets into the vehicle 1 while the vehicle 1 is parked using the AVP service, the deactivation of the immobilizer may be disabled. This allows the user X to quickly put the vehicle 1 into a state in which the travel system 23 can be started up by the operation of the user X himself/herself. Then, as described above, when the user X requests the continuation of the AVP service after performing the unlocking operation or after getting into the vehicle 1, the deactivation of the immobilizer may be re-enabled. This makes it possible to return the vehicle 1 to a state in which the travel system 23 can be started up in response to the start-up request from the management system 10 in preparation for subsequent exit (i.e., check-out) of the vehicle 1 using the AVP service.

What is claimed is:

1. A vehicle control system for controlling a vehicle that operates in accordance with a remote instruction in a predetermined area, the vehicle control system comprising:
a management system configured to manage the vehicle; and
a control device mounted on the vehicle and configured to communicate with the management system, wherein in response to a handover start request from a user device operated by a user of the vehicle, the management system starts handover processing for transferring operating authority of the vehicle from the user to the management system,
based on a result of a first communication between the control device and a key of the vehicle, the vehicle control system executes key presence confirmation processing for confirming that the key is present within a predetermined range from the vehicle when the handover start request is given, and
after the presence of the key is confirmed by the key presence confirmation processing, the control device removes a prohibition on a start-up of a travel system of the vehicle by an immobilizer of the vehicle in response to a start-up request of the travel system from the management system, on a condition that a predetermined period is in progress after the presence of the key is confirmed.

2. The vehicle control system according to claim 1, wherein
the predetermined period ends when a handover period during which the operating authority is transferred from the user to the management system ends.

3. The vehicle control system according to claim 1, wherein
the predetermined period ends when the vehicle arrives at a pick-up area for the vehicle to leave the predetermined area.

4. The vehicle control system according to claim 2, wherein
the predetermined area is a parking lot that supports an automated valet parking service, and
when the user unlocks a door of the vehicle or gets into the vehicle while the vehicle is parked using the automated valet parking service in the parking lot, the control device disables the removal of the prohibition on the start-up.

5. The vehicle control system according to claim 4, wherein
when the user operates the user device to request continuation of the automated valet parking service after the user unlocks the door or gets into the vehicle while the vehicle is parked, the control device re-enables the removal of the prohibition on the start-up.

6. The vehicle control system according to claim 3, wherein
the predetermined area is a parking lot that supports an automated valet parking service, and
when the user unlocks a door of the vehicle or gets into the vehicle while the vehicle is parked using the automated valet parking service in the parking lot, the control device disables the removal of the prohibition on the start-up.

7. The vehicle control system according to claim 6, wherein
when the user operates the user device to request continuation of the automated valet parking service after the user unlocks the door or gets into the vehicle while the vehicle is parked, the control device re-enables the removal of the prohibition on the start-up.

8. The vehicle control system according to claim 1, wherein
the user device stores key information for causing the user device to function as a digital key of the vehicle,
the key is the digital key,
the control device includes one or more memory devices,
the handover start request is transmitted not only from the user device to the management system, but also from the user device functioning as the digital key to the control device via the first communication, and
in the key presence confirmation processing:
upon receiving the handover start request from the user device, the control device determines that the digital key is present within the predetermined range from the vehicle when the handover start request is given; and
the control device stores a result of confirming the presence of the digital key in the one or more storage devices.

9. The vehicle control system according to claim 8, wherein
the control device deletes the result of confirming the presence of the digital key from the one or more memory devices upon an end of the predetermined period.

10. The vehicle control system according to claim 1, wherein
the management system includes one or more memory devices, and
in the key presence confirmation processing:
the control device periodically attempts to perform the first communication with the key and periodically transmits, to the management system, a communication result indicating whether or not the first communication is established;
upon receiving the communication result indicating that the first communication is established when the handover start request is received, the management system determines that the key is present within the predetermined range from the vehicle when the handover start request is given; and
the management system stores a result of confirming the presence of the key in the one or more storage devices.

11. The vehicle control system according to claim 10, wherein
the management system deletes the result of confirming the presence of the key from the one or more memory devices upon an end of the predetermined period.

12. A vehicle control method for controlling a vehicle that operates in accordance with a remote instruction in a predetermined area, the vehicle control method, which is executed by a computer, comprising:
in response to a handover start request from a user device operated by a user of the vehicle, starting handover processing for transferring operating authority of the vehicle from the user to a management system that manages the vehicle;
based on a result of a first communication between a control device mounted on the vehicle and a key of the vehicle, executing key presence confirmation processing for confirming that the key is present within a predetermined range from the vehicle when the handover start request is given; and
after the presence of the key is confirmed by the key presence confirmation processing, removing a prohibition on a start-up of a travel system of the vehicle by an immobilizer of the vehicle in response to a start-up request of the travel system from the management system, on a condition that a predetermined period is in progress after the presence of the key is confirmed.
